(19) United States
(12) Patent Application Publication
(10) Pub. No.: US 2005/0071574 A1
(43) Pub. Date: Mar. 31, 2005

(54) Architecture with shared memory

(76) Inventors: Rudi Frenzel, Munchen (DE); Christain Horak, Vaterstetten (DE); Raj Kumar Jain, Mandarin Gardens (SG); Markus Terschluse, 85579 Neubiberg (DE); Stefan Uhlemann, Munchen (DE)

Correspondence Address: Harold C Moore;Maginot Moore & Beck, Bank One Center/Tower, 111 Monument Circle Suite 3000, Indianapolis, IN, 46204, US

(21) Appl. No.: 10/494,808

(22) PCT Filed: Nov. 6, 2002
(86) PCT No.: PCT/EP02/12398

Related U.S. Application Data
(60) Provisional application No. 60/333,220, filed on Nov. 6, 2001.

(51) Int. Cl. G06F 12/00

(52) U.S. Cl. 711/148; 711/150; 711/5

(57) ABSTRACT

A system with multiple processors sharing a single memory module without noticeable performance degradation is described. The memory module is divided into n independently addressable banks, where n is at least 2 and mapped such that sequential addresses are rotated between the banks. Such a mapping causes sequential data bytes to be stored in alternate banks. Each bank may be further divided into a plurality of blocks. By staggering or synchronizing the processors to execute the computer program such that each processor access a different block during the same cycle, the processors can access the memory simultaneously.

This application claims priority of provisional patent application U.S. Ser. No. 60/333,220, filed on Nov. 6, 2001, which is herein incorporated by reference.

### FIELD OF THE INVENTION

The present invention relates generally to integrated circuits (ICs). More particularly, the invention relates to an improved architecture with shared memory.

### BACKGROUND OF THE INVENTION

FIG. 1 shows a block diagram of a portion of a conventional SOC 100, such as a digital signal processor (DSP). As shown, the SOC includes a processor 110 coupled to a memory module 160 via a bus 180. The memory module stores a computer program comprising a sequence of instructions. During operation of the SOC, the processor retrieves and executes the computer instructions from memory to perform the desired function.

An SOC may be provided with multiple processors that execute, for example, the same program. Depending on the application, the processors can execute different programs or share the same program. Generally, each processor is associated with its own memory module to improve performance because a memory module can only be accessed by one processor during each clock cycle. Thus, with its own memory, a processor need not wait for memory to be free since it is the only processor that will be accessing its associated memory module. However, the improved performance is achieved at the sacrifice of chip size since duplicate memory modules are required for each processor.

As evidenced from the above discussion, it is desirable to provide systems in which the processors can share a memory module to reduce chip size without incurring the performance penalty of conventional designs.

### SUMMARY OF THE INVENTION

The invention relates, in one embodiment, to a method of sharing a memory module between a plurality of processors. The memory module is divided into n banks, where n=at least 2. Each bank can be accessed by one or more processors at any one time. The memory module is mapped to allocate sequential addresses to alternate banks of the memory, where sequential data are stored in alternate banks due to the mapping of the memory. In one embodiment, the memory banks are divided into x blocks, where x=at least 1, wherein each block can be accessed by one of the plurality of processors at any one time. In another embodiment, the method further includes synchronizing the processors to access different blocks at any one time.

### BRIEF DESCRIPTION OF THE DRAWINGS

FIG. 1 shows a block diagram of conventional SOC;

FIG. 2 shows a system in accordance with one embodiment of the invention;

FIGS. 3-5 show a flow of FCU in accordance with different embodiments of the invention; and

FIGS. 6-7 show memory modules in accordance with various embodiments of the invention.

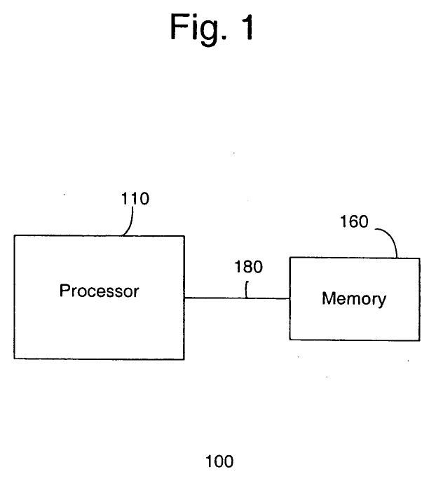

### PREFERRED EMBODIMENTS OF THE INVENTION

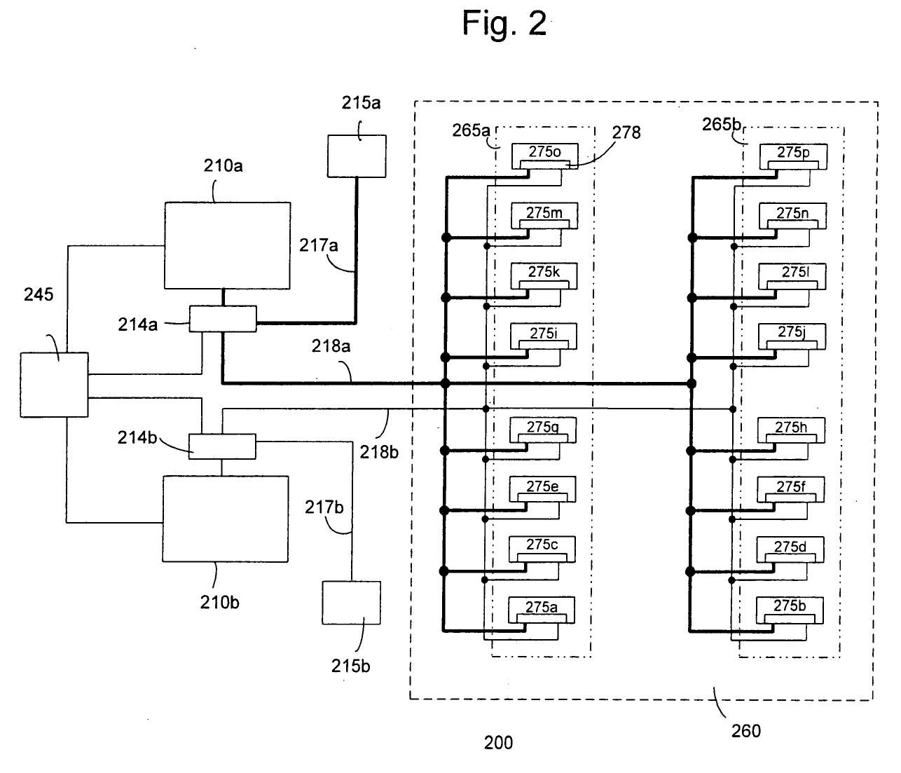

FIG. 2 shows a block diagram of a portion of a system 200 in accordance with one embodiment of the invention. The system comprises, for example, multiple digital signal processors (DSPs) for multi-port digital subscriber line (DSL) applications on a single chip. The system comprises m processors 210, where m is a whole number equal to or greater than 2. Illustratively, the system comprises first and second processors 210a-b (m=2). Providing more than two processors in the system is also useful.

The processors are coupled to a memory module 260 via respective memory buses 218a and 218b. The memory bus, for example, is 16 bits wide. Other size buses can also be used, depending on the width of each data byte. Data bytes accessed by the processors are stored in the memory module. In one embodiment, the data bytes comprise program instructions, whereby the processors fetch instructions from the memory module for execution.

In accordance with one embodiment of the invention, the memory module is shared between the processors without noticeable performance degradation, eliminating the need to provide duplicate memory modules for each processor. Noticeable performance degradation is avoided by separating the memory module into n number of independently operable banks 265, where n is an integer greater than or equal to 2. Preferably, n=the number of processors in the system (i.e. n=m). Since the memory banks operate independently, processors can simultaneously access different banks of the memory module during the same clock cycle.

In another embodiment, a memory bank is subdivided into x number of independently accessible blocks 275a-p, where x is an integer greater than or equal to 1. In one embodiment, each bank is subdivided into 8 independently accessible blocks. Generally, the greater the number of blocks, the lower the probability of contention. The number of blocks, in one embodiment, is selected to optimize performance and reduce contention.

In one embodiment, each processor (210a or 210b) has a bus (218a or 218b) coupled to each bank. The blocks of the memory array, each have, for example control circuitry 278 to appropriately place data on the bus to the processors. The control circuitry comprises, for example, multiplexing circuitry or tri-state buffers to direct the data to the right processor. Each bank, for example, is subdivided into 8 blocks. By providing independent blocks within a bank, processors can advantageously access different blocks, irrespective of whether they are from the same bank or not. This further increases system performance by reducing potential conflicts between processors.

Furthermore, the memory is mapped so that contiguous memory addresses are rotated between the different memory banks. For example, in a two-bank memory module (e.g., bank 0 and bank 1), one bank (bank 0) would be assigned the even addresses while odd addresses are assigned to the other bank (bank 1). This would result in data bytes in sequential addresses being stored in alternate memory banks, such as data byte 1 in bank 0, data byte 2 in bank 1, data byte 3 in bank 0 and so forth. The data bytes, in one embodiment, comprise instructions in a program. Since program instructions are executed in sequence with the exception of jumps (e.g., branch and loop instructions), a processor would generally access different banks of the memory module after each cycle during program execution. By synchronizing or staggering the processors to execute the program so that the processors access different memory banks in the same cycle, multiple processors can execute the same program stored in memory module 260 simultaneously.

A flow control unit (FCU) 245 synchronizes the processors to access different memory blocks to prevent memory conflicts or contentions. In the event of a memory conflict (e.g. two processors accessing the same block simultaneously), the FCU locks one of the processors (e.g. inserts a wait state or cycle) while allowing the other processor to access the memory. This should synchronize the processors to access different memory banks in the next clock cycle. Once synchronized, both processors can access the memory module during the same clock cycle until a memory conflict caused by, for example, a jump instruction, occurs. If both processors (210a and 210b) tries to access block 275a in the same cycle, a wait state is inserted in, for example, processor 210b for one cycle, such that processor 210a first accesses block 275a. In the next clock cycle, processor 210a accesses block 275b and processor 210b accesses block 275a. The processors 210a and 210b are hence synchronized to access different memory banks in the subsequent clock cycles.

Optionally, the processors can be provided with respective critical memory modules 215. The critical memory module, for example, is smaller than the main memory module 260 and is used for storing programs or subroutines which are accessed frequently by the processors (e.g., MIPS critical). The use of critical memory modules enhances system performance by reducing memory conflicts without going to the extent of significantly increasing chip size. A control circuit 214 is provided. The control circuit is coupled to bus 217 and 218 to appropriately multiplex data from memory module 260 or critical memory module 215. In one embodiment, the control circuit comprises tri-state buffers to decouple and couple the appropriate bus to the processor.

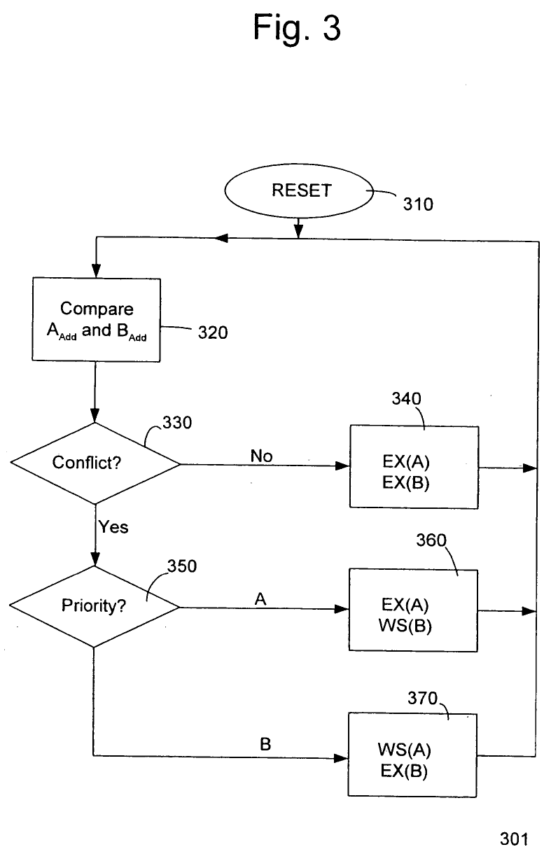

In one embodiment, the FCU is implemented as a state machine. FIG. 3 shows a general process flow of a FCU state machine in accordance with one embodiment of the invention. As shown, the FCU controls accesses by the processors (e.g., A or B). At step 310, the FCU is initialized. During operation, the processors issue respective memory addresses (A_{Add} or B_{Add}) corresponding to the memory access in the next clock cycle. The FCU compares A_{Add} and B_{Add} at step 320 to determine whether there is a memory conflict or not (e.g., whether the processors are accessing the same or different memory blocks). In one embodiment, the FCU checks the addresses to determine if any critical memory modules are accessed (not shown). If either processor A or processor B is accessing its respective local critical memory, no conflict occurs.

If no conflict exists, the processors access the memory module at step 340 in the same cycle. If a conflict exists, the FCU determines the priority of access by the processors at step 350. If processor A has a higher priority, the FCU allows processor A to access the memory while processor B executes a wait state at step 360. If processor B has a higher priority, processor B accesses the memory while processor A executes a wait state at step 370. After step 340, 360, or 370, the FCU returns to step 320 to compare the addresses for the next memory access by the processors. For example, if a conflict exists, such as at step 360, a wait state is inserted for processor B while processor A accesses the memory at address A_{Add}. Hence, both processors are synchronized to access different memory blocks in subsequent cycles.

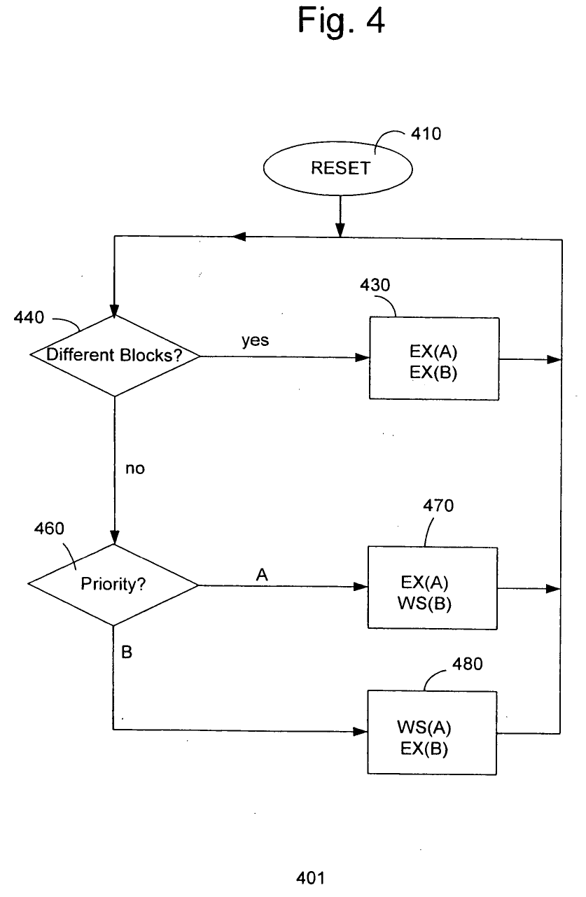

FIG. 4 shows a process flow 401 of an FCU in accordance with another embodiment of the invention. In the case of a conflict, the FCU assigns access priority at step 460 by examining processor A to determine whether it has executed a jump or not. In one embodiment, if processor B has executed a jump, then processor B is locked (e.g. a wait state is executed) while processor A is granted access priority. Otherwise, processor A is locked and processor B is granted access priority.

In one embodiment, the FCU compares the addresses of processor A and processor B in step 440 to determine if the processors are accessing the same memory block. In the event that the processors are accessing different memory blocks (i.e., no conflict), the FCU allows both processors to access the memory simultaneously at step 430. If a conflict exists, the FCU compares, for example, the least significant bits of the current and previous addresses of processor A to determine access priority in step 460. If the least significant bits are not equal (i.e. the current and previous addresses are consecutive), processor B may have caused the conflict by executing a jump. As such, the FCU proceeds to step 470, locking processor B while allowing processor A to access the memory. If the least significant bits are equal, processor A is locked and processor B accesses the memory at step 480.

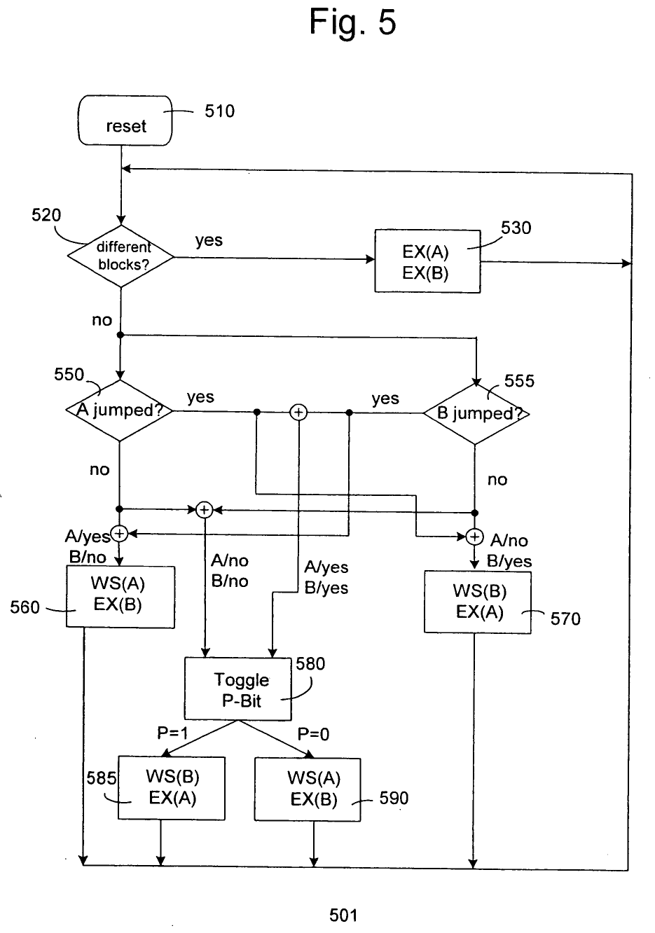

FIG. 5 shows an FCU 501 in accordance to an alternative embodiment of the invention. Prior to operation, the FCU is initialized at step 510. At step 520, the FCU compares the addresses of processors to determine it they access different memory blocks. If the processors are accessing different memory blocks, both processors are allowed access at step 530. However, if the processors are accessing the same memory block, a conflict exists. During a conflict, the FCU determines which of the processors caused the conflict, e.g., performed a jump. In one embodiment, at steps 550 and 555, the least significant bits of the current and previous addresses of the processors are compared. If processor A caused the jump (e.g., least significant bits of previous and current address of processor A are equal while least significant bits of previous and current address of processor B are not), the FCU proceeds to step 570. At step 570, the FCU locks processor A and allows processor B to access the memory at step 570. If processor B caused the jump, the FCU locks processor B while allowing processor A to access the memory at step 560.

A situation may occur where both processors performed a jump. In such a case, the FCU proceeds to step 580 and examines a priority register which contains the information indicating which processor has priority. In one embodiment, the priority register is toggled to alternate the priority between the processors. As shown in FIG. 5, the FCU toggles the priority register at step 580 prior to determining which processor has priority. Alternatively, the priority register can be toggled after priority has been determined. In one embodiment, a 1 in the priority register indicates that processor A has priority (step 585) while a 0 indicates that processor B has priority (step 590). Using a 1 to indicate that B has priority and a 0 to indicate that A has priority is also useful. The same process can also be performed in the event a conflict occurred in which neither processor performed a jump (e.g., least significant bits of the current and previous addresses of processor A or of processor B are not the same).

In alternative embodiments, other types of arbitration schemes can be also be employed by the FCU to synchronize the processors. In one embodiment, the processors may be assigned a specific priority level vis-à-vis the other processor or processors.

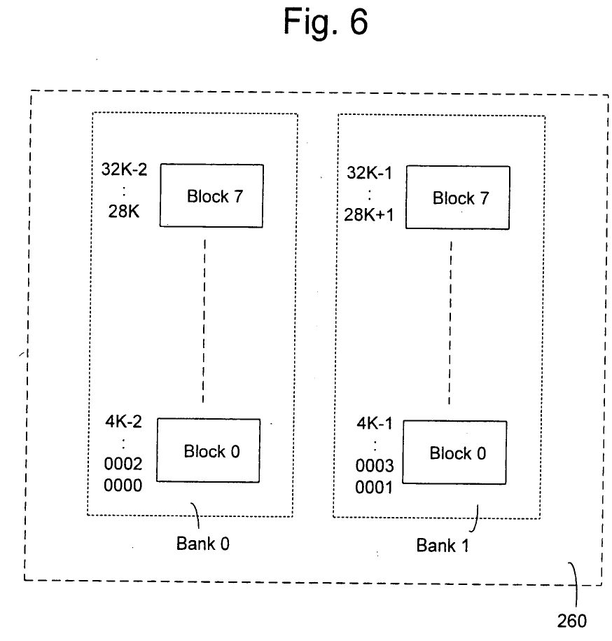

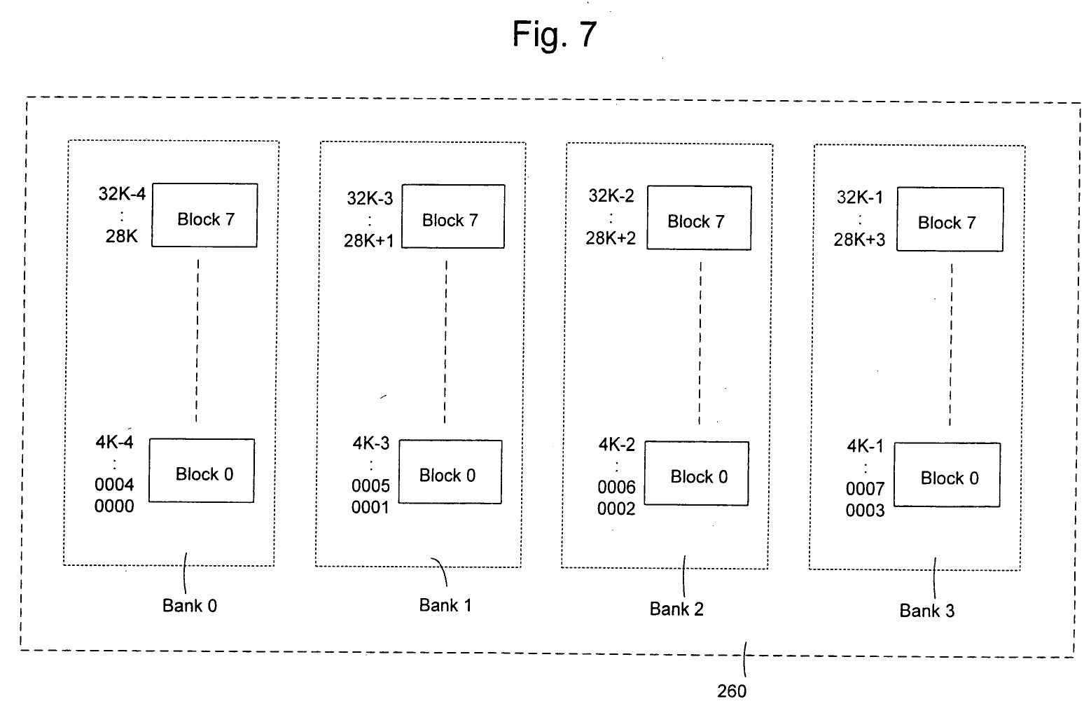

FIGS. 6-7 illustrate the mapping of memory in accordance with different embodiments of the invention. Referring to FIG. 6, a memory module 260 with 2 banks (Bank 0 and Bank 1) each subdivided into 8 blocks (Blocks 0-7) is shown. Illustratively, assuming that the memory module comprises 512 Kb of memory with a width of 16 bits, each block being allocated 2K addressable locations (2K×16 bits×16 blocks). In one embodiment, even addresses are allocated to bank 0 (i.e., 0, 2, 4 . . . 32K−2) and odd addresses to bank 1 (i.e., 1, 3, 5 . . . 32K−1). Block 0 of bank 0 would have addresses 0, 2, 4 . . . 4K−2; block 1 of bank 1 would have addresses 1, 3, 5 . . . 4K−1.

Referring to FIG. 7, a memory module with 4 banks (Banks 0-3) each subdivided into 8 blocks (Blocks 0-7) is shown. Assuming that the memory module 512 Kb of memory with a width of 16 bits, than each block is allocated 1K addressable locations (1K×16 bits×32 blocks). In the case where the memory module comprises 4 banks, as shown in FIG. 5, the addresses would be allocated as follows:
Bank 0: every fourth address from 0 (i.e., 0, 4, 8, etc.)
Bank 1: every fourth address from 1 (i.e., 1, 5, 9, etc.)
Bank 2: every fourth address from 2 (i.e., 2, 6, 10, etc.)
Bank 3: every fourth address from 3 (i.e., 3, 7, 11, etc.)
   The memory mapping can be generalized for n banks as follows:
Bank 0: every n^{th} address beginning with 0 (i.e., 0, n, 2n, 3n, etc.)
Bank 1: every n^{th} address beginning with 1 (i.e., 1, 1+n, 1+2n, 1+3n, etc.)
Bank n−1: every n^{th} address beginning with n−1 (i.e., n−1, n−1+n, n−1+2n, etc.)

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

1. A method of sharing a memory module between a plurality of processors comprising:
dividing the memory module into at least two banks, wherein each bank can be accessed by one or more of the plurality of processors at any one time;
mapping the memory module to allocate sequential addresses to alternate banks of the memory; and
storing data bytes in the memory module, wherein said data bytes in sequential addresses are stored in alternate banks due to the mapping of the memory.

2. The method of claim 1 further comprising a step of dividing each bank into at least one block, wherein each block can be accessed by one of the plurality of processors at any one time.

3. The method of claim 2 further comprising a step of determining whether two or more of the plurality of processors are accessing the same block at any one time.

4. The method of claim 3 further comprising a step of synchronizing the plurality of processors to access different blocks at any one time.

5. The method of claim 4 further comprising a step of determining access priorities of the plurality of processors.

6. The method of claim 5 wherein the step of determining access priorities comprises assigning lower access priorities to processors that have caused the memory conflict.

7. The method of claim 6 wherein the step of determining access priorities comprises assigning lower access priorities to processors that performed a jump.

8. The method of claim 6 wherein the step of synchronizing the processors comprises locking processors with lower priorities for one or more cycles.

9. A system comprising:
a plurality of processors;
a memory module comprising at least two banks, wherein each bank can be accessed by one or more of the plurality of processors at any one time;
a memory map for allocating sequential addresses to alternate banks of the memory module; and
data bytes stored in the memory module, wherein said data bytes in sequential addresses are stored in alternate banks according to the memory map.

10. The system of claim 9 wherein each bank comprises at least one block, wherein each block can be accessed by one of the plurality of processors at any one time.

11. The system of claim 10 further comprising a flow control unit for synchronizing the processors to access different blocks at any one time.

12. The system of claim 11 further comprising a priority register for storing an access priority of each of the plurality of processors.

13. The system of claim 9 wherein said data bytes comprise program instructions.

14. The system of claim 9 further comprising a plurality of critical memory modules for storing a plurality of data bytes for each of the plurality of processors for reducing memory access conflicts.

15. A system comprising:
a. a plurality of processors;
b. a plurality of memory banks connected to the plurality of processors;
c. a flow control unit connected to the plurality of processors, the flow control unit operable to determine whether two or more of the plurality of processors are attempting to access the same memory bank of the plurality of memory banks at substantially the same time; and
d. a plurality of data bytes stored in the plurality of memory banks, wherein the data bytes having sequential addresses of the plurality of data bytes are stored in an alternating manner between memory banks of the plurality of memory banks.

16. The system of claim 15 further comprising a critical memory module connected to each of the plurality of processors, each critical memory module storing data that is accessed by the respective processor.

17. The system of claim 16 further comprising a control circuit provided in the connection between one of the plurality of processors and one of the critical memory modules, the control circuit for multiplexing data from the critical memory module and another memory source.

18. The system of claim 17 wherein the control circuit is further provided in the connection between the one of the plurality of processors and the plurality of memory banks.

19. The system of claim 18 wherein the control circuit is further provided in the connection between the flow control unit and the one of the plurality of processors.

20. The system of claim 15 further comprising a priority register for storing an access priority of each of the plurality of processors.
